(19) United States
(12) Patent Application Publication
(10) Pub. No.: US 2013/0340317 A1
(43) Pub. Date: Dec. 26, 2013

(54) Tackle Box with Rod Holder

(71) Applicant: Michael Kevin Skiles, Lincoln City, OR (US)

(72) Inventor: Michael Kevin Skiles, Lincoln City, OR (US)

(21) Appl. No.: 13/918,972

(22) Filed: Jun. 16, 2013

Related U.S. Application Data
(60) Provisional application No. 61/664,513, filed on Jun. 26, 2012.

(51) Int. Cl. A01K 97/06; A01K 97/10

(52) U.S. Cl. CPC A01K 97/06; A01K 97/10
USPC 43/21.2; 43/54.1

(57) ABSTRACT

A tackle box with a rod holder for use during fishing activities is provided herein. The rod holder is detachably attached to the tackle box. A rod holder mount attached or molded into one of the tackle box lids secures the rod holder. The rod holder swivels horizontally 360 degrees and can tilt up or down so that a fishing rod secured in the rod holder can be oriented as the user desires. The rod holder possesses a ground stake that allows the rod holder to be removed from the tackle box and used independently. Once the ground stake is driven into soil, dirt, or even loose rocks, the rod holder is rotatable and can tilt up or down allowing a fishing rod to be properly oriented. The tackle box has adequate storage space and internal compartments for keeping fishing tackle stored and organized. The fishing tackle is still accessible even when a fishing rod is mounted in the rod holder and the rod holder is attached to the tackle box. The rod holder can be used by right handed or left handed users by providing embodiments with the tightening knob on the appropriate side of the rod holder.

### CROSS-REFERENCES TO RELATED APPLICATIONS

This application claims priority to U.S. Provisional Patent Application Ser. No. 61/664,513 filed on Jun. 26, 2012 entitled “Multipurpose Fishing Tackle Box and Rod Holder”, the disclosure of which is hereby incorporated by reference.

### FIELD OF THE INVENTION

The present invention relates to multi-purpose fishing tackle boxes, and more specifically, to such storage devices which employ an integrated fishing rod holder.

### BACKGROUND OF THE INVENTION

Within the art of fishing, organization of the desired equipment is of the utmost importance. Fishermen often employ bags or containers or the like to store and carry equipment such as lures, bait, and other accessories to and from the location of their choice. Tackle boxes offer the most versatile solution to these needs, and present the user with a hard-shelled encasement featuring a plurality of internal structures for sorting and organizing their equipment. The rigidity of the external shell can be useful for supporting the weight of the user, and protecting the contents from damage.

Due to the varied terrain experienced during fishing, fishermen often make use of trees, rocks, or other objects to prop their fishing rods in a fashion conducive to the sport. Devices emulating these supportive structures are well known within the art. Free-standing rod holders often feature a means of subterranean anchoring system such as staking, drilling, and otherwise securing the holder in a manner such that the rod cannot be easily moved. Unfortunately, this requires the user to transport those holders and their accompanying hardware. The nature of such holders can make them cumbersome to transport, and consequently, may take up too much space within a tackle box. Another disadvantage of these holders is the need to be pushed into the ground. This act can be challenging, and in the case of the rocky terrain commonly found near bodies of water, near impossible.

It could be said there lies a need for a convenient, easily transported fishing rod holder that can attach to the user's tackle box or can be used in-ground without the need to carry additional equipment and still provides access to stored tackle while in use.

The present invention meets these needs by providing the user with a tackle box featuring a detachable fishing rod holder.

### BRIEF SUMMARY OF THE INVENTION

It is therefore an object of the present invention to overcome the shortcomings and deficiencies of the prior art.

The present invention was conceived with the shortcomings and deficiencies of the prior art in mind and one object is to provide a tackle box with a fishing rod holder.

It is another object of the present invention to provide a tackle box with a fishing rod holder that is lightweight and can be easily transported.

It is yet another object of the present invention for the tackle box to maintain, in an organized manner, an assortment of tackle within the tackle box.

It is still another object of the present invention for the fishing rod holder to hold a fishing rod in a manner that does not interfere with access to tackle stored within the tackle box.

It is yet another object of the present invention for the fishing rod holder to hold a fishing rod in a multitude of positions, angles, or orientations as necessary for fishing purposes.

It is still another object of the present invention for the fishing rod holder to detach from the tackle box and independently hold a fishing rod during fishing activities.

It is yet another object of the present invention to provide a fishing rod holder that can be driven into the ground and support a fishing rod when not attached to the tackle box.

It is still another object of the present invention to provide a fishing rod holder that can hold fishing rods of many sizes.

It is yet another object of the present invention to provide a tackle box with rod holder that can be leveled when used on uneven terrain.

It is still another object of the present invention for the tackle box to hold one or more beverages.

It is yet another object of the present invention for the tackle box with rod holder that can be partially or completely opened while holding a fishing rod.

It is still another object of the present invention to provide a cost-effective tackle box with rod holder that can easily and efficiently be manufactured and sold to customers.

It is yet another object of the present invention to provide a tackle box with rod holder where a knob used to set the vertical position of a fishing rod is on the right side of the rod holder or on the left side of the rod holder so that the present invention can be used by right-handed or left-handed users.

In accordance with the objects of the invention described above, the present invention provides tackle box with a detachable rod holder that can hold a fishing rod during fishing activities. The tackle box with rod holder has several components that, when taken together, form the entire invention. One component of the tackle box with rod holder is its construction material. The tackle box with rod holder is constructed of conventional lightweight yet durable materials such as plastic, polymers, metals, or metal alloys. It is important to note that certain embodiments of the present invention may be constructed entirely of one type of material. Yet other embodiments of the present invention may be constructed from differing materials. In an embodiment where the rod holder is constructed of differing materials the tackle box is be constructed from a lightweight plastic, and the rod holder is be constructed from a lightweight metal such as aluminum. Yet other embodiments of the present invention may be constructed from combinations of materials. In an embodiment where the present invention is constructed from combinations of materials, the rod holder is made from a polymer and has brass screws that resist corrosion.

Another component of the present invention is a detachably attached rod holder that holds a fishing rod during fishing activities. The rod holder is of a universal design and can securely hold many different types or sizes of fishing rods during fishing activities. The rod holder is secured to the tackle box by way of a rod holder mount that allows for vertical and horizontal rotation of the rod holder. The rod holder mount is integrated as part of one lid of the tackle box. However, in some embodiments of the present invention, the rod holder mount can be attached, by way of bolts or screws, to the lid of the tackle box. When in use, the rod holder is inserted into the mount and can be rotated horizontally through 360 degrees to properly position a fishing rod. The rod holder can also be removed from the mount and used as a stand-alone rod holding apparatus. In an embodiment of the present invention, the rod holder has a stake that is driven into loose or semi-compact soil, sand, or loose rocks to secure the rod holder. In some embodiments of the present invention, the spike is foldable or removable for easy storage when not in use. In other embodiments of the present invention the spike is fixed and not movable

Some embodiments of the present invention include a means for leveling the tackle box when used on uneven terrain. The means for leveling the tackle box is a metal plate that is attached to the exterior of the tackle box and allows the front end of the box to be lifted so that the box, rod holder, and fishing rod may be kept level. Different embodiments of the present invention have the metal plate affixed to the tackle box in a variety of ways depending on the need and particular application. The metal plate may be attached by a hinge connected to the bottom of the tackle box so that the plate folds out of the way when not in use. The metal plate may also be attached to the tackle box by a sliding mechanism that allows the plate to slide in or out from the box. The metal plate may also be directly affixed to the tackle box in a permanent, non-movable position. The various methods of attaching the metal plate to the tackle box are considered different embodiments of the present invention and are intended to be included within the scope of the invention.

One exemplary embodiment of the present invention provides a tackle box with rod holder for use while fishing. This embodiment of the present invention has a detachably attached rod holder that fits into a rod holder mount that is molded into the lid of the tackle box. The rod holder rotates horizontally through 360 degrees and also can tilt vertically through a wide degree of arc so that a fishing rod secured in the rod holder can be oriented as the user desires. The rod holder possesses a ground stake that is attached to the bottom of the rod holder that allows the rod holder to be removed from the tackle box and driven into the ground. Most commonly, the user will drive the rod holder into soil, dirt, or even loose rocks. Once driven into the ground, the rod holder is still horizontally and vertically adjustable allowing a fishing rod to be properly oriented. In this embodiment, the tackle box has adequate storage space and internal compartments for keeping fishing tackle stored and organized.

Another exemplary embodiment of the present invention provides tackle box with a detachable rod holder and a means for leveling the tackle box. The rod holder can rotate through 360 degrees horizontally and can tilt up or down vertically so that a fishing rod secured in the rod holder can be oriented as the user desires. The rod holder mount can either be molded as part of the lid of the tackle box, or can be mounted to the lid by bolt or screw-type fasteners. A metal plate is secured by a hinge to the bottom of the tackle box and can be folded out to level the tackle box when fishing on uneven terrain. In an alternative embodiment of the present invention, the metal plate slides out from the bottom of the tackle box. In yet another embodiment of the present invention, the metal plate is attached in a permanent, non-movable position.

The preceding brief description is intended to merely outline some objects and advantages of the present invention. The following disclosure will set forth other objects and advantages of the present invention along with novel features that distinguish the present invention from the prior art. It is to be understood that the following disclosure is by no means intended to limit the scope of the present invention or any of its embodiments. It is also to be understood that the accompanying illustrations are presented for descriptive purposes only and similarly are not intended to limit the scope of present invention or any of its embodiments. The following disclosure and accompanying illustrations may describe various features of novelty that characterize the invention. The invention does not reside any particular feature when taken in the singular, but in the combination of features as described herein.

### BRIEF DESCRIPTION OF THE SEVERAL VIEWS OF THE IMAGE(S)

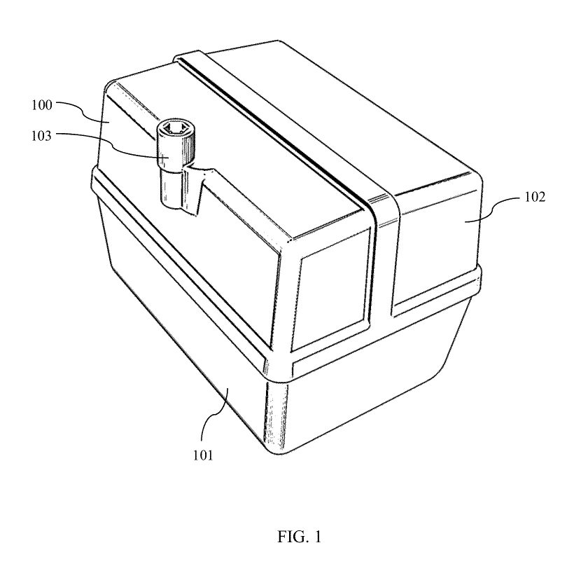

FIG. 1 is an isometric view of a tackle box with an integrated rod holder mount as according to one embodiment of the present invention;

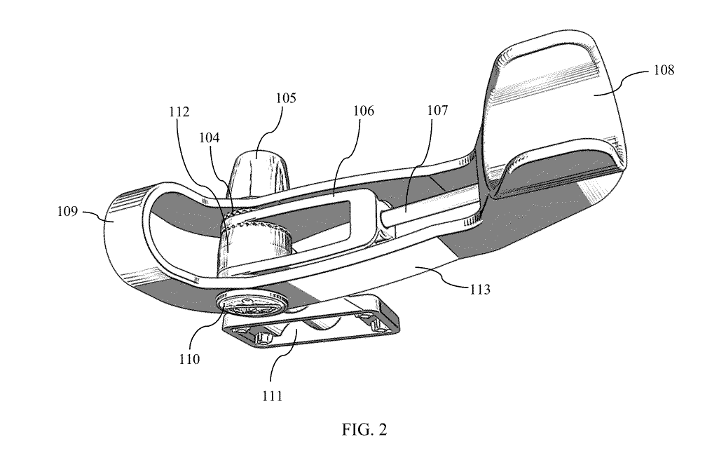

FIG. 2 is a top isometric view of a rod holder as according to one embodiment of the present invention;

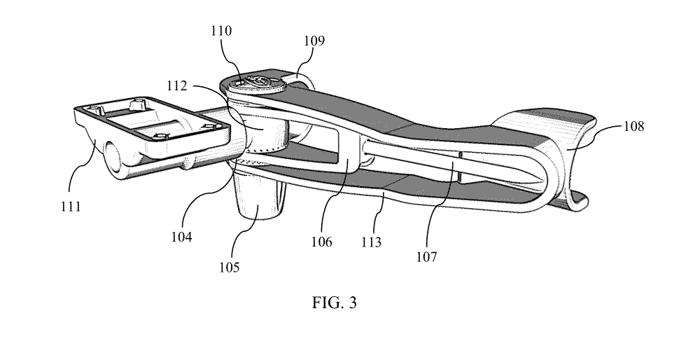

FIG. 3 is a bottom isometric view of a rod holder as according to one embodiment of the present invention;

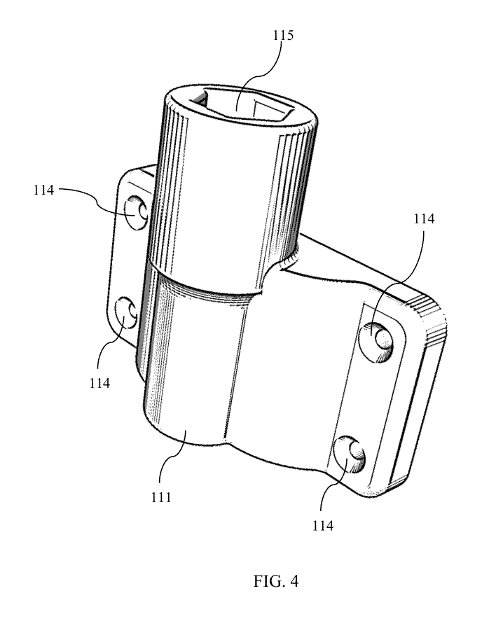

FIG. 4 is a front isometric view of a non-integrated rod holder mount as according to one embodiment of the present invention;

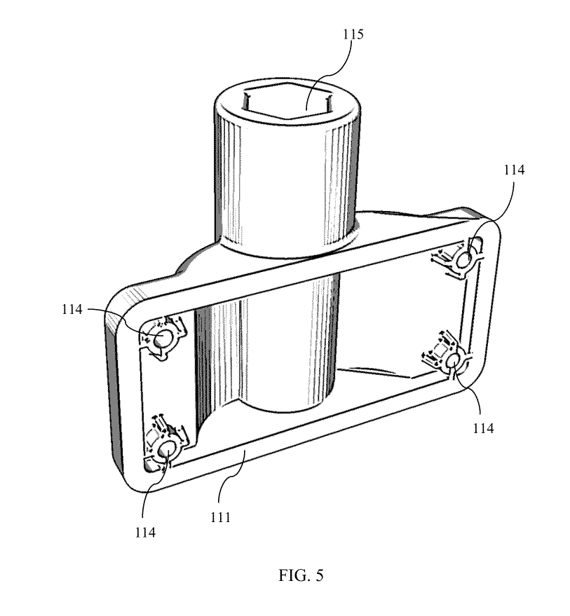

FIG. 5 is a rear isometric view of a non-integrated rod holder mount as according to one embodiment of the present invention;

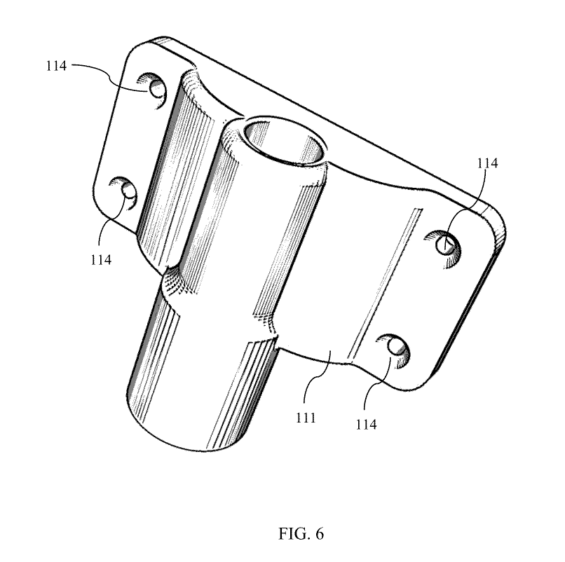

FIG. 6 is a bottom isometric view of a non-integrated rod holder mount as according to one embodiment of the present invention;

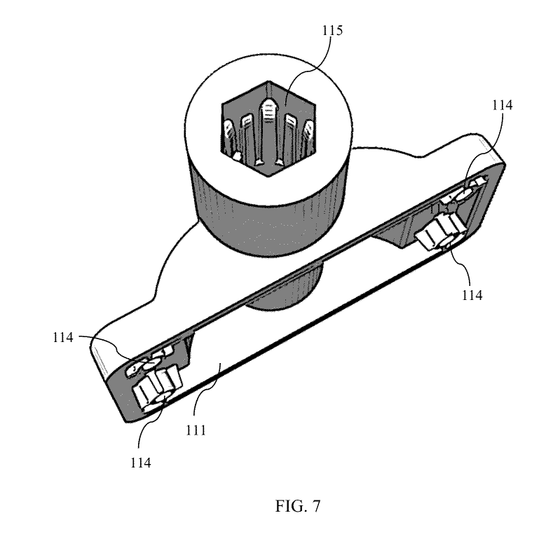

FIG. 7 is an interior view of a non-integrated rod holder mount as according to one embodiment of the present invention;

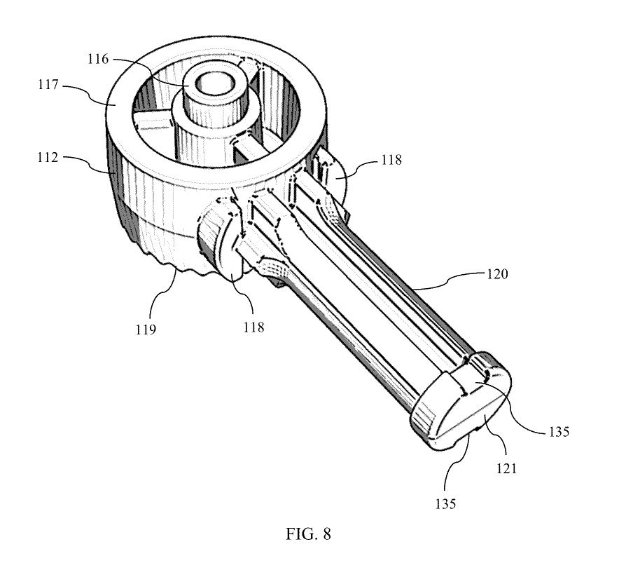

FIG. 8 is a front isometric view of a rod holder pin as according to one embodiment of the present invention;

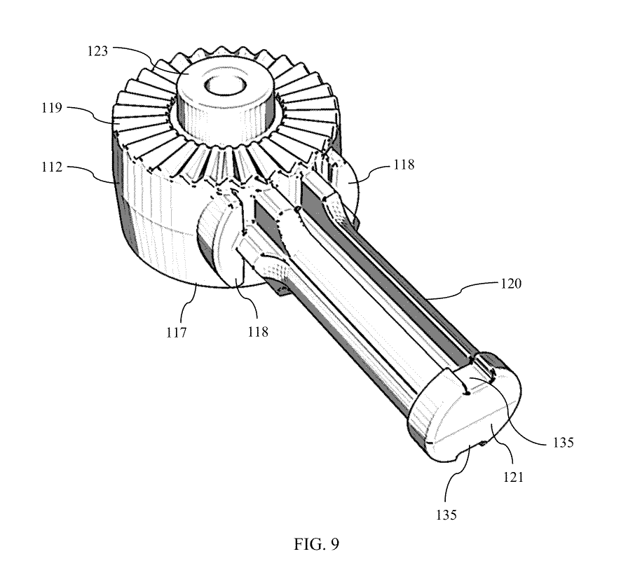

FIG. 9 is a rear isometric view of a rod holder pin as according to one embodiment of the present invention;

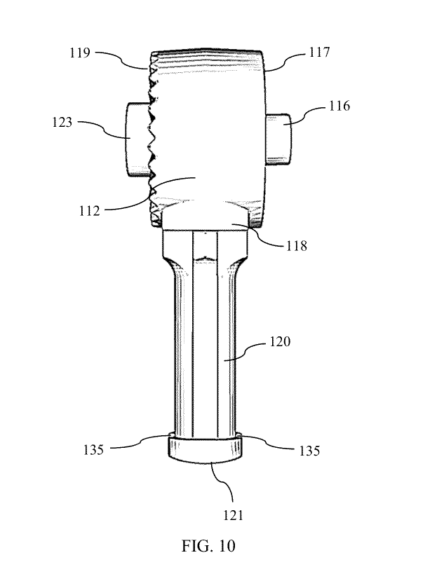

FIG. 10 is a side view of a rod holder pin as according to one embodiment of the present invention;

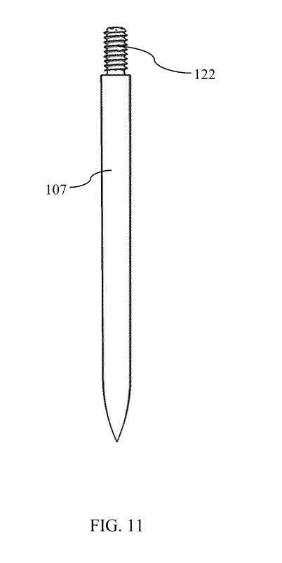

FIG. 11 is a front view of a ground stake as according to one embodiment of the present invention;

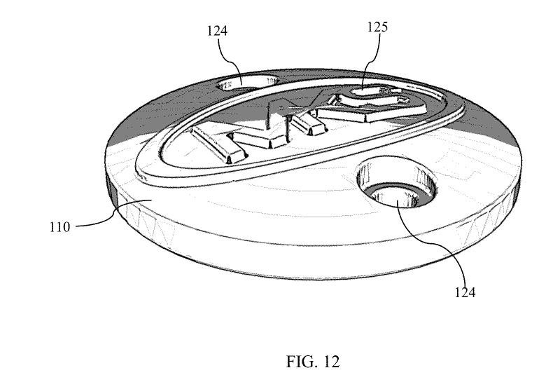

FIG. 12 is an isometric view of a rod holder nameplate as according to one embodiment of the present invention;

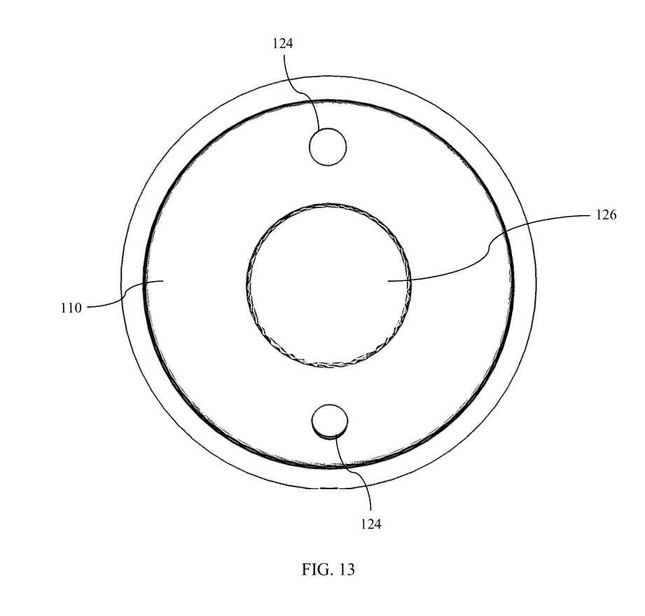

FIG. 13 is a rear view of a rod holder nameplate as according to one embodiment of the present invention;

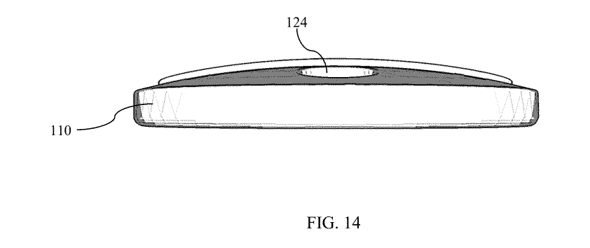

FIG. 14 is side view of a rod holder nameplate as according to one embodiment of the present invention;

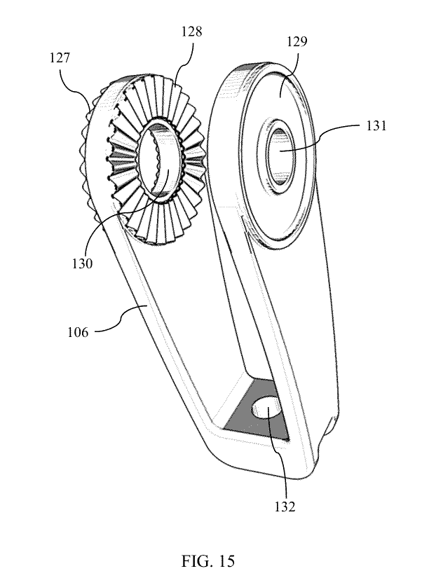

FIG. 15 is an isometric view of a stake base as according to one embodiment of the present invention;

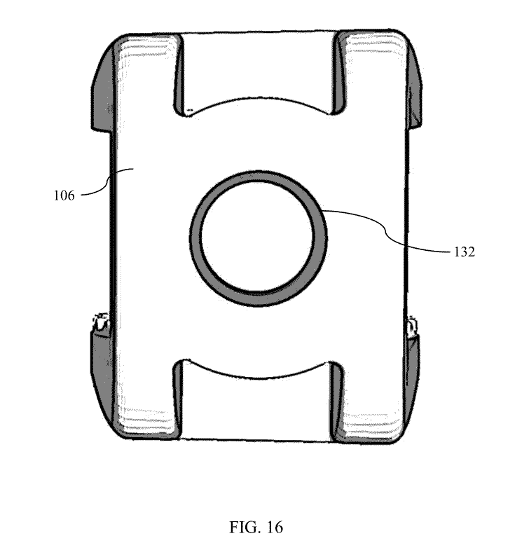

FIG. 16 is a bottom view of a stake base as according to one embodiment of the present invention;

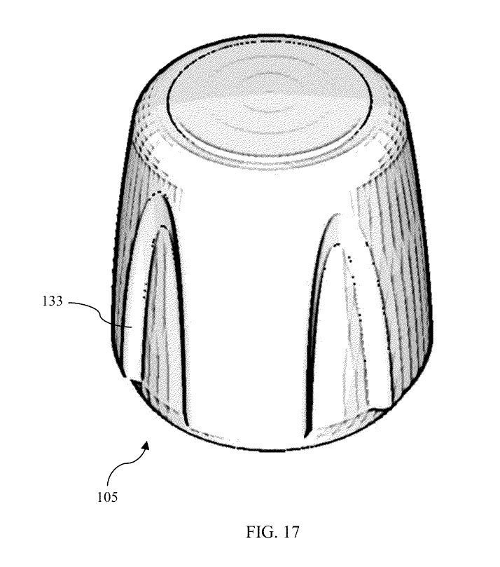

FIG. 17 is a front isometric view of a rod holder knob as according to one embodiment of the present invention; and

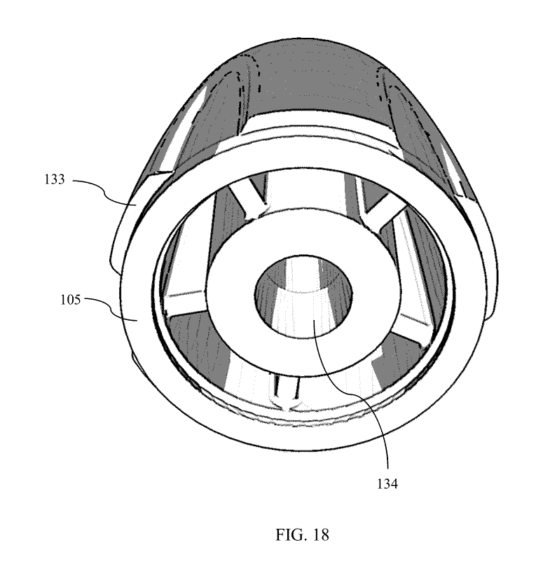

FIG. 18 is a rear isometric view of a rod holder knob as according to one embodiment of the present invention.

### DETAILED DESCRIPTION OF THE INVENTION

In the following detailed description, reference is made to the accompanying images that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by appended claims, appropriately interpreted, along with the full range of equivalents to which the claims are entitled.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

The terms “tackle box with rod holder”, “present invention”, and “invention” may be used interchangeably. The terms “fishing rod” and “rod” may also be used interchangeably. It is within the scope of this invention that the terms “fishing rod” and “rod” also apply to any fishing apparatus commonly referred to as “fishing poles” or “poles”. The terms “fishing pole” and “pole” may be substituted for the terms “fishing rod” and “rod” throughout this specification without deviating from the scope of the present invention. In addition to the functions, features, components, and abilities of the invention already discussed in this specification, the tackle box with rod holder may also have, but not be limited to, the following features contained within the description set forth herein.

Several preferred embodiments of the tackle box with rod holder are discussed in this section. However, the invention is not limited to these embodiments. The tackle box with rod holder, as according to the present invention, is any tackle box that can hold a fishing rod during fishing activities in an integrated or non-integrated rod holder that is mounted to a lid of the tackle box. The tackle box with rod holder securely holds the fishing rod in a horizontal and vertical orientation that is set by the user. Various features of the present invention keep fishing tackle organized within the box and allow for the tackle to be accessed while a fishing rod is secured in the rod holder.

For the purpose of clarity, all like elements will have the same numbering and designations in each of the Figures. For this reason, individual Figures will not be referred to when discussing particular elements.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

Referring now to FIG. 1, there is shown a tackle box with an integrated rod holder mount (103) as according to one embodiment of the present invention. The tackle box bottom (101) is attached to a first lid (100) and a second lid (102) that can be opened or closed individually or together to access stored contents. Generally, the contents stored in the tackle box bottom (101) will be fishing tackle or related equipment. The integrated rod holder mount (103) is formed as part of the first lid (100). In this embodiment, the integrated rod holder mount (103) and the first lid (100) are formed from the same material to create a one-piece lid and mount assembly. The position of the integrated rod holder mount (103) is approximately near the centerline of the tackle box bottom (101) so that an attached fishing rod will not cause the tackle box to tilt forward or backward. When in use, a rod holder (113) is inserted down into the rod holder receiver opening (115) of the integrated rod holder mount (103). It should be noted that in some embodiments of the present invention, a non-integrated rod holder mount (111) may be used in place of the integrated rod holder mount (103).

Referring now to FIGS. 2 and 3 that will be discussed together, there is shown a top and a bottom isometric view of a rod holder (113) as according to one embodiment of the present invention. The rod holder (113) has a rod cradle (108) that supports a fishing rod during fishing activities. The rod cradle (108) supports the portion of the handle of a fishing rod that is located just behind the reel. However, for smaller rods, particularly children's rods, the rod cradle (108) may support the portion of the handle located just in front of the reel. For extremely small rods, the rod cradle (108) may support a portion of the butt of a fishing rod.

The rod holder (113) also has a rod handle cradle (109) that supports the butt cap or rear portion of a fishing rod handle. The rod handle cradle (109) forms an arch that extends over a fishing rod's butt cap or rear handle portion to create downward restraining pressure and to prevent the fishing rod from falling forward when in use. The rod handle cradle (109) is located on the opposite end of the rod holder (113) from the rod cradle (108) to provide a stable platform for securing a fishing rod while fishing.

A swivel pin (112) allows for vertical positioning of the rod holder (113) through tension that is applied by the user tightening a knob (105). The knob (105) may be located on the right side of the rod holder (113) for right-handed users, or may be located on the left side of the rod holder (113) for left-handed users. The scope of the present invention includes embodiments with the knob (105) located on either side of the rod holder (113). The tension increases or decreases friction applied to a smooth rotation surface (117) and a stepped rotation surface (119) of the swivel pin (112). When the knob (105) is loosened, tension is decreased and the rod holder (113) is free to rotate vertically. When the knob (105) is tightened, tension is increased and the stepped rotation surfaces of the rod holder base (104), swivel pin (119), and stake base (127, 128) lock together to prevent vertical movement. The knob (105) used for increasing or decreasing tension on the swivel pin (112) is described in further detail below.

The swivel pin (112) allows for horizontal positioning of the rod holder (113) by fitting into an integrated rod holder mount (103) or a non-integrated rod holder mount (111). The segment of the swivel pin (112) that fits into the integrated or non-integrated rod holder mount (103, 111), is a swivel pin shaft (120) that has grooves formed as part of the shaft. The grooves in the swivel pin shaft (120) fit around ridges within the integrated rod holder mount (103) or non-integrated rod holder mount (111) to prevent unwanted horizontal rotation of the rod holder (113). These ridges within the mounts (103, 111) can be seen in FIG. 7 which looks down into the swivel pin shaft receiver (115). The swivel pin (112) is described in further detail below.

A stake base (106) is connected between the swivel pin (112) and rod holder (113). The stake base (106) connects a ground stake (107) to the rod holder (113). The ground stake (107) is used by a fisherperson to secure the rod holder (113) to the ground when the rod holder (113) is detached from the tackle box and used independently. When the rod holder (113) is detached from the tackle box, the stake base (106) is rotated downward bringing the ground stake (107) into a usable position. The stake base (106) can be rotated through a degree of vertical arc so that the rod holder (113) is held at a proper elevation. The stake base (106) has an inner stepped rotation surface (128) and an outer stepped rotation surface (127) that lock into place with the stepped rotation surface of the rod holder (104) when the user applies tension by tightening the knob (105). For some applications, it is desirable to rotate the stake base (106) through a larger degree of vertical arc so that the rod holder (113) holds a fishing rod closer to parallel with the ground. In other applications it is desirable to rotate the stake base (106) through a smaller degree of arc so that the rod holder (113) holds a fishing rod at a greater angle to the ground. The stake base (106) and ground stake (107) are described in further detail below.

Referring now to FIGS. 4-7 that will be discussed together, there are shown isometric views of a non-integrated rod holder mount (111) as according to one embodiment of the present invention. The non-integrated rod holder mount (111) can be constructed of the same or different material as the first lid (100), second lid (102), or the tackle box bottom (101). Constructing the non-integrated rod holder mount (111) of the same material gives the present invention a uniform, homogenous appearance. A non-integrated rod holder mount (111) constructed of a different material may be required in certain embodiments where a stronger, more durable or more lightweight non-integrated rod holder mount (111) is required, or when retrofitting existing tackle boxes. These embodiments may include deep-sea fishing tackle boxes where rod size and weight often exceed comparable fresh-water counterparts.

The non-integrated rod holder mount (111) has fastener holes (114) through which screws or bolts pass to attach the non-integrated rod holder mount (111) to the first lid (100). The fastener holes are at the corners of the non-integrated rod holder mount (111) to resist torsional forces created by the fishing rod during fishing activities.

The non-integrated rod holder mount (111) has a ridged swivel pin shaft receiver (115) that receives the swivel pin shaft (120) of the swivel pin (112). The ridges in the receiver (115) fit into the grooves of the swivel pin shaft (120) to lock the rod holder (113) into place at particular horizontal orientations. This allows for fishing rods to rotate while in the rod holder (113) then be held in place at desired positions. The swivel pin shaft (120) can rotate clockwise or counterclockwise within the swivel pin shaft receiver (115).

Referring now to FIGS. 8-10 that will be discussed together, there are shown isometric views of a swivel pin (112) as according to one embodiment of the present invention. The swivel pin (112) has a small hub (116) that fits into the stake base (106) and allows the swivel pin (112) to rotate vertically. The swivel pin also has a large hub (123) that fits into the stake base (106) and also allows the swivel pin (112) to rotate vertically. A swivel pin smooth rotation surface (117) rests against the stake base (106) to provide a low-friction contact area between swivel pin (112) and the stake base (106).

When rotating the rod holder (113) vertically, the user decreases tension by loosening the knob (105) and the stake base (106) rotates against the swivel pin smooth rotation surface (117). When the user has reached the desired rod elevation, the user tightens the knob (105) and the swivel pin's stepped rotation surface (119) locks into place against the inner stepped rotation surface of the stake base (128). The tensioning of the knob (105) generates sufficient friction to prevent movement between the two stepped rotation surfaces (119, 128).

The swivel pin (112) has horizontal rotation pads (118) that rest upon the integrated or non-integrated rod holder mounts (103, 111) when the swivel pin (112) is inserted into the mounts (103, 111). The horizontal rotation pads (118) keep the swivel pin (112) separated from the mounts (103, 111) and slide around the top edge of the mounts (103, 111) when the rod holder (113) is rotated horizontally. The horizontal rotation pads (118) have smooth surfaces that contact the mounts (103, 111) to reduce friction and increase ease of rotating the rod holder (113).

The swivel pin shaft (120) is the component of the swivel pin (112) that fits into the swivel pin shaft receiver (115) of the integrated or non-integrated rod holder mounts (103, 111). The swivel pin shaft (120) has grooves running lengthwise that accommodate ridges located within the swivel pin shaft receiver (115). When a user rotates their fishing rod secured within the rod holder (113), the swivel pin shaft (120) rotates within the swivel pin shaft receiver (115). When the user finds a desired horizontal position for their fishing rod, the ridges within the swivel pin shaft receiver (115) fit into the grooves of the swivel pin shaft (120) thereby preventing unwanted horizontal movement.

A swivel pin base (121) has a larger diameter than the swivel pin shaft (120) to prevent the swivel pin (112) from coming dislodged or accidently falling out of the mounts (103, 113). The swivel pin base (121) fits into the mounts (103, 113) only when insertion grooves (135) on the swivel pin base (121) are lined up with the appropriate ridges within the mounts (103, 113). Once the swivel pin (112) is rotated, the insertion grooves (135) no longer line up with the ridges within the mounts (103, 113) and the larger diameter of the swivel pin base (121) prevents the swivel pin (112) from being pulled back up out of the mounts (103, 113) Similarly, the swivel pin (112) can only be removed from the mounts (103, 113) when the insertion grooves (135) are again aligned with the appropriate ridges within the mounts (103, 113).

Referring now to FIG. 11 there is shown a front view of a ground stake (107) as according to one embodiment of the present invention. The ground stake (107) is used when a user wishes to have their fishing rod be supported by the rod holder (113) independently of the tackle box. The ground stake (107) secures the rod holder (113) in place when it is driven into the ground. The ground stake is swung into position after the rod holder (113) is removed from the integrated or non-integrated mount (103, 113). When tension on the stake base (106) is lessened the ground stake (107) swings outward to a usable position. The stake base (106) can be swung in a wide degree of arc so that the user's fishing rod can be held parallel to the ground, at an elevated angle, or even at a declination. Once the desired angle of orientation is found, tension is reapplied by tightening the knob (105) and the stake base (106) is locked in place between the swivel pin (112) and the rod holder (113).

The ground stake (107) is attached to the stake base (106) by stake threads (122) that allow the ground stake (107) to screw a threaded stake receptacle (132) to the bottom of the stake base (106). In some embodiments of the present invention, the ground stake (107) is formed as a single unit with the stake base (106). These embodiments typically cast the stake base (106) and ground stake (107) from a single piece of metal or mold the two elements from a single piece of plastic or polymer.

Referring now to FIGS. 12-14 that will be discussed together, there are shown views of a rod holder nameplate (110) as according to one embodiment of the present invention. The rod holder nameplate (110) is primarily a decorative or identification element that carries a logo or identification information (125). A logo (125) can be molded as part of the rod holder nameplate (125) or can be placed on after molding, such as by way of a sticker or painting on the logo. The rod holder nameplate (110) is secured to the rod holder (113) by fasteners that pass through the nameplate fastener holes (124). A nameplate underside indentation (126) is formed in the bottom of the rod holder nameplate (110) that allows the small hub (116) of the swivel pin (112) to fit within the indentation (126). By allowing the small hub (116) to fit within the indentation (112) the rod holder nameplate (110) has sufficient clearance to sit flush against the side of the rod holder (113).

Referring now to FIGS. 15 and 16 that will be discussed together, there are shown views of a stake base (106) as according to one embodiment of the present invention. The stake base (106) has a large hub housing (130) into which the large hub (123) of the swivel pin (112) is inserted. The stake base (106) also has a small hub housing (131) into which the small hub (116) of the swivel pin (112) is inserted. The large hub housing (130) and the small hub housing (131) allow the swivel pin (112) to rotate vertically for proper fishing rod positioning.

The stake base (106) has an outer smooth rotation surface (129) that contacts the fishing rod holder (113). The outer smooth rotation surface (129) reduces friction between the stake base (106) and the rod holder (113) when the rod holder (113) is vertically rotated. When the proper vertical orientation is achieved, the user tightens the knob (105) and tension is applied to the outer stepped rotation surface (127) and the inner stepped rotation surface (128) of the stake base. The outer stepped rotation surface (127) rests against the rod holder base stepped rotation surface (104) while the inner stepped rotation surface (128) rests against the swivel pin stepped rotation surface (119). The stepping characteristics of these aforementioned surfaces (127, 128, 104, 119) fit together in a manner that prevents under vertical movement of the rod holder (113) when the knob (105) is tightened.

To attach the ground stake (107) to the stake base (106), a threaded stake receptacle (132) is formed as part of the bottom of the stake base (106). The threaded stake receptacle (132) has threads that allow the ground stake (107) to thread into the stake base (106). In some embodiments of the present invention, the ground stake (107) is formed as part of the stake base (106) eliminating the need for the threaded stake receptacle (132). In those embodiments, the stake base (106) and ground stake (107) are formed as a single piece of metal, plastic, or polymer.

Referring now to FIGS. 17 and 18 that will be discussed together, there are shown isometric views of a rod holder knob (105) as according to one embodiment of the present invention. The rod holder knob (105) has raised finger grips (133) that make it easier for a user to grip the knob (105) particularly when the knob (105) is slippery due to coatings of mud, dirt, water, or fish parts. The rod holder knob (105) has a knob attachment opening (134) that allows the knob (105) to fit onto the rod holder (113). The knob attachment hole is shaped so that an axle running through the rod holder (113), swivel pin (112), and stake base (106) can also extend partway into the knob (105). It is the axle that holds the components together and around which vertical rotation of the rod holder occurs.

The embodiment of the rod holder knob (105) illustrated in FIGS. 17 and 18 is positioned on the right side of the rod holder (113) so that right-handed users may use the invention. Other embodiments of the present invention have the rod holder knob (105) positioned on the left side of the rod holder (113) so that left-handed users may use the invention. It is within the scope of the invention to include rod holders (113) with a rod holder knob (105) located on the right side or the left side of the rod holder (113) so that users of right-hand dominance or users of left-hand dominance may use the invention.

Not shown but intended to be included within the scope of the present invention is a metal leveling plate attached to underside of the tackle box bottom (101). The metal plate is a means for leveling the present invention when used on uneven terrain. The metal plate allows the front end of the tackle box to be elevated so that the tackle box, rod holder (113) and a user's fishing rod is held in the proper orientation. Furthermore, by leveling the invention the metal plate prevents slippage down the uneven terrain.

The metal place is secured to the underside of the tackle box bottom (101) by a hinge connected to the tackle box bottom (101). In an alternate embodiment of the present invention, the metal plate is secured by a mechanism that allows the plate to slide in and out from underneath the tackle box bottom (101). In yet another embodiment of the present invention, the metal plate is affixed to the tackle box bottom (101) in a permanent, unmovable position.

As set forth in this description and the attached images, an improved tackle box with rod holder has been developed that improves upon conventional tackle boxes. The various embodiments of the improved tackle box with rod holder described herein can be used in a wide variety of fishing applications. Some of these fishing applications include, but are not limited to, fly-fishing, deep-sea fishing, shore or beach fishing, freshwater fishing, and ice fishing.

The preceding exemplary embodiments are not intended to be limiting, but are merely illustrative for the possible uses of the tackle box with rod holder.

Although certain example methods, apparatus and articles of manufacture have been described herein, the scope of coverage of this patent is not limited thereto. On the contrary, this patent covers all methods, apparatus and articles of manufacture fairly falling within the scope of the invention either literally or under the doctrine of equivalents.

With respect to the above description then, it is to be realized that the optimum dimensional relationships for the parts of the tackle box with rod holder, to include variations in size, materials, shape, form, function and the manner of operation, and use, are deemed readily apparent and obvious to one skilled in the art, and all equivalent relationships to those illustrated in the images and described in the specification are intended to be encompassed by the tackle box with rod holder.

Directional terms such as “right”, “left”, “front”, “back”, “in”, “out”, “downward”, “upper”, “lower”, “top”, “bottom”, “inner”, “outer”, “large”, “small” and the like have been used in the description. These terms are applicable to the embodiments shown and described in conjunction with the images. These terms are merely used for the purpose of description in connection with the images and do not necessarily apply to the position in which the tackle box with rod holder may be used.

Therefore, the foregoing is considered as illustrative only of the principles of the tackle box with rod holder. Further, since numerous modifications and changes will readily occur to those skilled in the art, it is not desired to limit the tackle box with rod holder to the exact construction and operation shown and described, and accordingly, all suitable modifications and equivalents may be resorted to, falling within the scope of the tackle box with rod holder. While the above description describes various embodiments of the present invention, it will be clear that the present invention may be otherwise easily adapted to fit any configuration where tackle box with rod holder is desired or required.

As various changes could be made in the above constructions without departing from the scope of the invention, it is intended that all matter contained in the above description or shown in the accompanying images shall be interpreted as illustrative and not in a limiting sense.

What is claimed is:

1. A tackle box with a detachable rod holder for use during fishing activities comprising:
a tackle box that stores fishing tackle in an organized manner having a first lid, a second lid, and a bottom; a rod holder mount attached to the first lid of the tackle box; a detachable rod holder that holds a fishing rod during fishing activities, a swivel pin that connects the detachable rod holder to the rod holder mount and allows for horizontal rotation of the detachable rod holder when the detachable rod holder is connected to the rod holder mount, a ground stake that can be driven into the ground when the detachable rod holder is detached from the tackle box, a rotatable stake base that connects the ground stake to the detachable rod holder and allows for vertical rotation ground stake, a knob for increasing or decreasing tension on the detachable rod holder and swivel pin to lock the detachable rod holder in a vertical orientation or release the detachable rod holder from a vertical orientation; wherein the second lid of the tackle box can be opened to access stored fishing tackle within the tackle box while the detachable rod holder is connected to the rod holder mount.

2. The tackle box with detachable rod holder of claim 1, further comprising a metal plate attached to the bottom of the tackle box that is used to level the tackle box when fishing on uneven terrain.

3. The tackle box with detachable rod holder of claim 1, wherein the rod holder mount is integrated as part of the first lid of the tackle box.

4. The tackle box with detachable rod holder of claim 1, wherein the detachable rod holder has a stepped rotation surface that contacts an outer stepped rotation surface of the stake base.

5. The tackle box with detachable rod holder of claim 1, wherein the stake base has an inner stepped rotation surface that contacts a stepped rotation surface on the swivel pin.

6. The tackle box with detachable rod holder of claim 1, wherein the rod holder mount has ridges that fit into grooves on the swivel pin to lock the rod holder in a horizontal orientation.

7. The tackle box with detachable rod holder of claim 1, wherein the detachable rod holder can be rotated horizontally 360 degrees when mounted in the rod holder mount.

8. An apparatus comprising:
a generally box-shaped structure with internal compartments for storing and keeping fishing tackle organized; a rod holder capable of vertical and horizontal adjustment having a rod cradle that supports the forward part of the handle of a fishing rod, a rod handle cradle arches over the butt cap or rear portion of a fishing rod handle, the rod cradle and rod handle cradle being located on opposite ends of the rod holder; a lid that encloses a portion of the box-shaped structure; a mount that connects the rod holder to the lid; a swivel pin that is inserted into the mount when the rod holder and the mount are connected, the swivel pin being capable of rotating horizontally within the mount; a knob that tightens the rod holder in a desired vertical orientation; a ground stake that can be driven into the ground when the rod holder is detached from the mount; a stake base that connects the ground stake to the rod holder and allows for rotation of the ground stake; and a second lid that provides access to fishing tackle within the box-shaped structure when the rod holder is connected to the mount and when the rod holder is detached from the mount.

9. The apparatus of claim 8, wherein the rod holder holds a fishing rod when connected to the mount and when detached from the mount.

10. The apparatus of claim 8, wherein the mount is an integrated component of the lid.

11. The apparatus of claim 8, wherein the horizontal position of the rod holder is maintained by ridges within the mount fitting into grooves within the shaft of the swivel pin.

12. The apparatus of claim 8, wherein the ground stake rotates into the rod holder when the rod holder is inserted into the mount.

13. The apparatus of claim 8, further comprising a nameplate attached to the rod holder that bears a logo or identification.

14. A rod holder that can hold a fishing rod during fishing activities when the rod holder is attached to a tackle box and when the rod holder is used independently of the tackle box, the rod holder comprising:
a plurality of components including a rod cradle that supports a fishing rod from underneath; a rod handle cradle that arches over the rear portion of the handle of a fishing rod; a swivel pin with a grooved shaft that can be inserted into a mount on a lid of the tackle box, the swivel pin being capable of rotating through 360 degrees of horizontal travel when inserted into the mount; a stake base that connects a ground stake to the rod holder; a knob that is used to increase or reduce tension between the rod holder, swivel pin, and stake base in order to secure the rod holder in a desired vertical orientation; a series of stepped rotation surfaces on the rod holder, swivel pin, and stake base that lock together to prevent vertical movement of the rod holder when the knob is used to increase tension; and the rod holder being shaped to allow for access to the contents of the tackle box through a second tackle box lid when the rod holder is attached to the tackle box.

15. The rod holder of claim 14, wherein the swivel pin further comprises a base that prevents the rod holder from inadvertently coming dislodged from the mount.

16. The rod holder of claim 15, wherein the swivel pin base further comprises insertion grooves that must line up with internal ridges within the mount before the rod holder can be inserted into the mount.

17. The rod holder of claim 14, wherein the ground stake is attached to the stake base by screwing into a threaded receptacle at the bottom of the stake base.

18. The rod holder of claim 14, wherein the ground stake and the stake base are formed as a single unit.

19. The rod holder of claim 14 further comprising a nameplate attached to the side of the rod holder.

20. The rod holder of claim 14, wherein the knob has raised finger grips.
